(19) United States
(12) Patent Application Publication
(10) Pub. No.: US 2021/0076450 A1
(43) Pub. Date: Mar. 11, 2021

(54) DATA SERVICE PROCESSING METHOD, NETWORK SIDE DEVICE, TERMINAL DEVICE, AND STORAGE MEDIUM

(71) Applicant: VIVO MOBILE COMMUNICATION CO., LTD., Dongguan (CN)

(72) Inventors: Dajie JIANG, Dongguan (CN); Xueming PAN, Dongguan (CN)

(73) Assignee: VIVO MOBILE COMMUNICATION CO., LTD., Dongguan (CN)

(21) Appl. No.: 16/953,155

(22) Filed: Nov. 19, 2020

Related U.S. Application Data
(63) Continuation of application No. PCT/CN2019/089153, filed on May 30, 2019.

(30) Foreign Application Priority Data
Jun. 13, 2018 (CN) 201810610166.3

(51) Int. Cl. H04W 76/28; H04W 76/27; H04W 72/04; H04W 74/08

(52) U.S. Cl. CPC H04W 76/28; H04W 76/27; H04W 74/0833; H04W 72/0413; H04W 72/0453

(57) ABSTRACT

An exemplary method for data service processing is provided. The method is applied to a terminal device and includes sending a configuration request to a network side device, where the configuration request comprises one or more of a first configuration sub-request for a Discontinuous Reception (DRX) parameter, a second configuration sub-request for a Radio Resource Control (RRC) state, and a third configuration sub-request for a component carrier and a Bandwidth Part (BWP). The method further includes reconfiguring one or more of the DRX parameter, the RRC state, the component carrier, and the BWP, and performing data service processing based on the reconfigured one or more of the DRX parameter, the RRC state, the component carrier, and the BWP; or receiving feedback information that is sent by the network side device in response to the configuration request, and performing data service processing based on the feedback information.

### CROSS-REFERENCE TO RELATED APPLICATIONS

This application is a bypass continuation of PCT Application No. PCT/CN2019/089153 filed May 30, 2019, which claims priority to Chinese Patent Application No. 201810610166.3 filed in China on Jun. 13, 2018, both of which are incorporated herein by reference in their entireties.

### TECHNICAL FIELD

The present disclosure relates to the field of communications technologies, and in particular, to a data service processing method, a network side device, a terminal device, and a storage medium.

### BACKGROUND

The long term evolution (Long Term Evolution, LTE) communications system and the 5th generation mobile communications (The 5th Generation mobile communication, 5G) system support high-speed data transmission and diversified business services, but also accelerate power consumption of a terminal device. The problem of power consumption of the terminal device affects a user's sense of identity to the communications system.

A discontinuous reception (Discontinuous Reception, DRX) mechanism is a terminal power-saving solution proposed by the 3rd generation partnership project (The 3rd Generation Partnership Project, 3GPP) standard working group. The basic idea is as follows: During a use process of the terminal device, when there is no data transmission, the terminal device enters a sleep mode to reduce power consumption and prolong battery life.

In the related technologies, a DRX parameter in a communications network is basically fixed and will not be adjusted according to different requirements of different services. If a DRX parameter such as an onDurationTimer parameter, an InactivityTimer parameter, or a long cycle related parameter is configured unreasonably, a probability that the terminal device blindly detects a physical downlink control channel (Physical Downlink Control Channel, PDCCH) but no PDCCH is detected is greatly increased, and in addition, the power consumption of the terminal device may be severe.

### SUMMARY

Embodiments of the present disclosure provide a method for data service processing, a network side device, a terminal device, and a storage medium, which can reduce a probability that the terminal device blindly detects a PDCCH but no PDCCH is detected, so as to improve data transmission efficiency and save power of the terminal device.

According to a first aspect, an embodiment of the present disclosure provides a method for data service processing, where the method includes: receiving a configuration request from a terminal device, where the configuration request includes one or more of a first configuration sub-request for a DRX parameter, a second configuration sub-request for a radio resource control (Radio Resource Control, RRC) state, and a third configuration sub-request for a component carrier and a bandwidth part (Bandwidth Part, BWP); and sending, to the terminal device, feedback information in response to the configuration request, so that the terminal device performs data service processing based on the feedback information.

According to a second aspect, an embodiment of the present disclosure provides a method for data service processing, where the method includes: sending a configuration request to a network side device, where the configuration request includes one or more of a first configuration sub-request for a DRX parameter, a second configuration sub-request for an RRC state, and a third configuration sub-request for a component carrier and a BWP; and reconfiguring one or more of the DRX parameter, the RRC state, the component carrier, and the BWP, and performing data service processing based on the reconfigured one or more of the DRX parameter, the RRC state, the component carrier, and the BWP; or receiving feedback information that is sent by the network side device in response to the configuration request, and performing data service processing based on the feedback information.

According to a third aspect, an embodiment of the present disclosure provides a network side device, where the network side device includes a first receiving module and a first sending module, where the first receiving module is configured to receive a configuration request from a terminal device, where the configuration request includes one or more of a first configuration sub-request for a DRX parameter, a second configuration sub-request for an RRC state, and a third configuration sub-request for a component carrier and a BWP; and the first sending module is configured to send, to the terminal device, feedback information in response to the configuration request, so that the terminal device performs data service processing based on the feedback information.

According to a fourth aspect, an embodiment of the present disclosure provides a terminal device, where the terminal device includes a second sending module, a processing module, and a configuration module or a second receiving module, where the second sending module is configured to send a configuration request to a network side device, where the configuration request includes one or more of a first configuration sub-request for a DRX parameter, a second configuration sub-request for an RRC state, and a third configuration sub-request for a component carrier and a BWP; the configuration module is configured to reconfigure one or more of the DRX parameter, the RRC state, the component carrier, and the BWP; the second receiving module is configured to receive feedback information that is sent by the network side device in response to the configuration request; and the processing module is configured to perform data service processing based on items reconfigured by the configuration module or based on the feedback information received by the second receiving module.

According to a fifth aspect, an embodiment of the present disclosure provides a network side device, where the network side device includes a memory, a processor, and a computer program stored in the memory and executable on the processor, where the computer program, when executed by the processor, implements the method for data service processing according to the foregoing first aspect.

According to a sixth aspect, an embodiment of the present disclosure provides a terminal device, where the terminal device includes a memory, a processor, and a computer program stored in the memory and executable on the processor, where the computer program, when executed by the processor, implements the method for data service processing according to the foregoing second aspect.

According to a seventh aspect, an embodiment of the present disclosure provides a computer readable storage medium, where the computer readable storage medium stores a computer program, and the computer program, when executed by a processor, implements the method for data service processing according to the foregoing first aspect or the foregoing second aspect.

According to the method for data service processing, the network side device, the terminal device, and the storage medium that are provided in the embodiments of the present disclosure, the terminal device sends the configuration request to the network side device, where the configuration request includes one or more of the first configuration sub-request for the DRX parameter, the second configuration sub-request for the RRC state, and the third configuration sub-request for the component carrier and the BWP; the network side device sends, to the terminal device, the feedback information in response to the configuration request; and the terminal device performs the data service processing based on the feedback information. A probability that the terminal device blindly detects a PDCCH but no PDCCH is detected can be reduced, so as to improve data transmission efficiency and save power of the terminal device.

### BRIEF DESCRIPTION OF DRAWINGS

To describe the technical solutions in the embodiments of the present disclosure more clearly, the following briefly describes the accompanying drawings required in the embodiments of the present disclosure. A person of ordinary skill in the art may still derive other drawings from these accompanying drawings without creative efforts.

FIG. 1 is a schematic diagram of a scenario according to an embodiment of the present disclosure;

FIG. 2 is a schematic flowchart of a data service processing method applied to a network side device according to an embodiment of the present disclosure;

FIG. 3 is a first schematic flowchart of a data service processing method applied to a terminal device according to an embodiment of the present disclosure;

FIG. 4 is a second schematic flowchart of a data service processing method applied to a terminal device according to an embodiment of the present disclosure;

FIG. 5 is a schematic structural diagram of a network side device according to an embodiment of the present disclosure;

FIG. 6 is a first schematic structural diagram of a terminal device according to an embodiment of the present disclosure;

FIG. 7 is a second schematic structural diagram of a terminal device according to an embodiment of the present disclosure;

FIG. 8 is a schematic structural diagram of hardware of a network side device according to an embodiment of the present disclosure; and

FIG. 9 is a schematic structural diagram of hardware of a terminal device according to an embodiment of the present disclosure.

### DETAILED DESCRIPTION

The features and exemplary embodiments of each aspect of the present disclosure will be described below in detail. To make the objectives, technical solutions, and advantages of the present disclosure more clearly, the following further describes the present disclosure in detail with reference to the accompanying drawings and embodiments. It should be understood that the specific embodiments described herein are only configured to explain the present disclosure, but are not configured to limit the present disclosure. For a person skilled in the art, the present disclosure may be implemented without some of these specific details. The following description of the embodiments is only to provide a better understanding of the present disclosure by showing examples of the present disclosure.

It should be noted that in this specification, relational terms such as first and second are used only to differentiate an entity or operation from another entity or operation, and do not require or imply that any actual relationship or sequence exists between these entities or operations. In addition, the terms “comprise”, “include” and any other variants thereof are intended to cover non-exclusive inclusion, so that a process, a method, an article, or a device that includes a series of elements not only includes these very elements, but may also include other elements not expressly listed, or also include elements inherent to this process, method, article, or device. Without being subject to further limitations, an element defined by a phrase “including . . . ” does not exclude presence of other identical elements in the process, method, article, or device that includes the very element.

A DRX mechanism is a terminal power-saving solution proposed by the 3GPP standard working group. The basic idea is as follows: During a use process of a terminal device, when there is no data transmission, the terminal device enters a sleep mode to reduce power consumption and prolong battery life. In the related technologies, a DRX parameter in a communications network is basically fixed and will not be adjusted according to different requirements of different services. As a result, a probability that the terminal device blindly detects a PDCCH but no PDCCH is detected is greatly increased, data transmission efficiency is relatively low, and power consumption of the terminal device is severe.

To resolve the related technical problems, embodiments of the present disclosure provide a data service processing method, a network side device, a terminal device, and a storage medium. The following first introduces the data service processing method provided in the embodiment of the present disclosure.

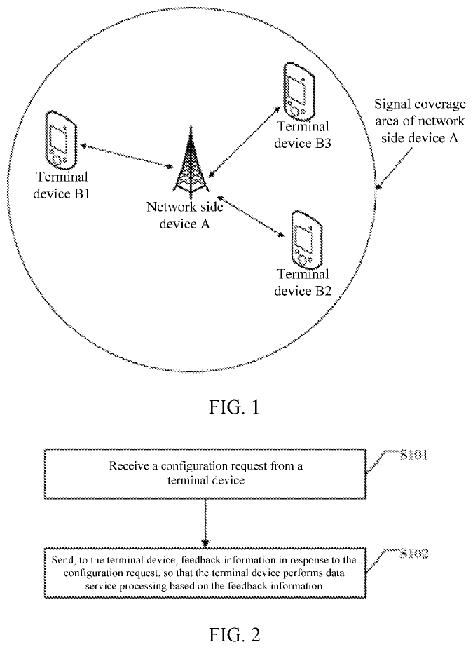

Embodiments of the present disclosure provide a data service processing method, a network side device, a terminal device, and a storage medium. In some examples, the terminal device may be a mobile phone, a tablet computer, a smart watch, a smart appliance, or the like, which is not limited herein. FIG. 1 is a schematic diagram of a scenario according to an embodiment of the present disclosure. As shown in FIG. 1, there are three terminal devices in a signal coverage area of a network side device A, namely: a terminal device B1, a terminal device B2, and a terminal device B3. The network side device A can perform uplink communication and downlink communication with each terminal device. The network side device A provided in this embodiment of the present disclosure may be a base station, where the base station may be a frequently used base station, or an evolved node base station (evolved node base station, eNB), or a device such as a network side device (for example, a next generation node base station (next generation node base station, gNB) or a transmission and reception point (transmission and reception point, TRP)) or a cell in the 5G system, or a network side device in a subsequent evolution communications system. However, the term used does not constitute a limitation to the protection scope of the present disclosure.

An embodiment of the present disclosure provides a data service processing method applied to a network side device. As shown in FIG. 2, FIG. 2 is a schematic flowchart of the data service processing method applied to the network side device according to an embodiment of the present disclosure. The data service processing method applied to the network side device may include the following steps:

S101: Receive a configuration request from a terminal device.

The configuration request includes one or more of a first configuration sub-request for a DRX parameter, a second configuration sub-request for an RRC state, and a third configuration sub-request for a component carrier and a BWP. The RRC state includes: an idle state, an inactive state and a connected state.

S102: Send, to the terminal device, feedback information in response to the configuration request, so that the terminal device performs data service processing based on the feedback information.

Compared with the network side device, the terminal device can learn some information better in real time, such as uplink service information, a remaining battery life of the terminal device, and whether a body of the terminal device is overheated. Therefore, the terminal device can determine a more appropriate DRX parameter, RRC state, and component carrier and/or BWP, and report the DRX parameter, RRC state, and component carrier and/or BWP to the network side device, so that a probability that the terminal device blindly detects a PDCCH but no PDCCH is detected is reduced, and the effects of improving data transmission efficiency and saving power of the terminal device are achieved.

Based on this, the terminal device can send, to the network side device, the configuration request that includes the first configuration sub-request for the DRX parameter, the second configuration sub-request for the RRC state, and/or the third configuration sub-request for the component carrier and/or the BWP, the network side device responds to the configuration request, and then the terminal device performs the data service processing based on the response of the network side device.

In an embodiment of the present disclosure, the first configuration sub-request for the DRX parameter, sent by the terminal device to the network side device, may be an initial configuration request for a DRX parameter or a reconfiguration request for a DRX parameter.

It may be understood that before the terminal device sends the initial configuration request for the DRX parameter to the network side device, the network side device does not enable a DRX function for the terminal device, and the terminal device cannot enter a sleep mode, so that the terminal device is relatively high and severe in power consumption. After the terminal device sends the initial configuration request for the DRX parameter to the network side device, the network side device enables the DRX function for the terminal device and configures a DRX parameter, and the terminal device can perform data service processing based on the configured DRX parameter and then enter a sleep mode, so that the effects of improving data transmission efficiency and saving power of the terminal device can be achieved.

It may also be understood that before the terminal device sends the reconfiguration request for the DRX parameter to the network side device, the network side device has enabled a DRX function for the terminal device and has configured a DRX parameter, but the DRX parameter configured for the terminal device cannot well improve data transmission efficiency and save power of the terminal device. Based on this, the terminal device may send the reconfiguration request for the DRX parameter to the network side device, the network side device reconfigures the DRX parameter, and the terminal device performs data service processing based on the reconfigured DRX parameter, so that the effects of improving the data transmission efficiency and saving the power of the terminal device can be achieved.

In an embodiment of the present disclosure, the terminal device may send the configuration request through a message 1 or a message 3 of a physical uplink shared channel (Physical Uplink Shared Channel, PUSCH), a physical uplink control channel (Physical Uplink Control Channel, PUCCH), or a physical random access channel (Physical Random Access Channel, PRACH), and correspondingly, the network side device may receive the configuration request from the terminal device through the PUSCH, the PUCCH, or the PRACH.

The PUSCH carries uplink control information and service data; the PUCCH carries uplink control information; and the PRACH is used for the terminal device to initiate communication with the network side device, the terminal device sends preamble information during random access, and the network side device receives the preamble information through the PRACH. The uplink control information and the preamble information may carry the configuration request for the DRX parameter.

In an embodiment of the present disclosure, the terminal device may send a factor that affects a DRX parameter to the network side device through the first configuration sub-request. In other words, the first configuration sub-request includes: the factor that affects the DRX parameter. The network side device reconfigures the DRX parameter based on the factor that affects the DRX parameter and that is in the received first configuration sub-request. The factor that affects the DRX parameter may include one or more of an uplink service packet arrival cycle, an uplink service packet size, an uplink data transmission rate, an uplink service delay requirement, a downlink service packet arrival cycle, a downlink service packet size, a downlink data transmission rate, a downlink service delay requirement, a remaining battery life of the terminal device, and a temperature of the terminal device.

For example, it is assumed that an uplink service is a Voice over Internet Protocol (Voice over Internet Protocol, VoIP) service, and a packet arrival cycle of the VoIP service is 20 milliseconds (millisecond, ms). The terminal device sends the packet arrival cycle of the VoIP service to the network side device through the first configuration sub-request. The network side device reconfigures, based on the packet arrival cycle of 20 ms of the VoIP service, a long cycle DRX parameter in the DRX parameter as 20 ms.

For example, it is assumed that an uplink service is a VoIP service, a packet size of the VoIP service is 40 bytes (Byte, B), and an acoustic code rate is 15.6 kilobits per second (kilobits per second, kbps). The terminal device sends the packet size of the VoIP service to the network side device through the first configuration sub-request. The network side device calculates, based on the packet size of 40 B and the acoustic code rate of 15.6 kbps of the VoIP service, time occupied by a VoIP service packet: 15.6 kbps/40 B/8 bits/byte=49.92 frames/second 50 frames/second, that is, one frame every 20 ms. A long cycle DRX parameter in the DRX parameter is reconfigured as 20 ms.

For example, it is assumed that an uplink service is a VoIP service, a total packet size of the VoIP service is 128 Kbytes (Kbytes, KB), and an uplink data transmission rate is 1 million bits per second (Million bits per second, Mbps). The terminal device sends the total packet size and the uplink data transmission rate of the VoIP service to the network side device through the first configuration sub-request. The network side device calculates, based on the total packet size of 128 KB and the uplink data transmission rate of 1 Mbps of the VoIP service, total time required to transmit a VoIP service packet: 128 KB/1 Mbps=1 second (second, s)=1000 ms. A long cycle DRX parameter in the DRX parameter is reconfigured as 1024 ms.

For example, it is assumed that an uplink service delay requirement is 1000 ms. The terminal device sends the uplink service delay requirement to the network side device through the first configuration sub-request. The network side device reconfigures, based on the uplink service delay requirement, a long cycle DRX parameter in the DRX parameter as 1024 ms.

It should be noted that, that the uplink service is the VoIP service in the foregoing is used as an example for description, which is only a specific embodiment of the present disclosure and does not constitute a limitation on the present disclosure.

A process of reconfiguring the DRX parameter based on the downlink service packet arrival cycle, the downlink service packet size, the downlink data transmission rate, and the downlink service delay requirement is basically the same as that of reconfiguring the DRX parameter based on the uplink service packet arrival cycle, the uplink service packet size, the uplink data transmission rate, and the uplink service delay requirement, which is not described in detail in this embodiment of the present disclosure.

For example, it is assumed that a remaining battery life of the terminal device is 20%. The terminal device sends the remaining battery life of the terminal device to the network side device through the first configuration sub-request. The network side device determines, based on the received remaining battery life, that the power of the terminal device is too low, and then reconfigures the DRX parameter, for example, reduces an onDurationTimer parameter and an InactivityTimer parameter, so that the terminal device can enter a sleep mode as soon as possible to reduce power consumption and prolong battery service time.

For example, it is assumed that a temperature of the terminal device is 60° C. The terminal device sends the temperature of the terminal device to the network side device through the first configuration sub-request. The network side device determines, based on the received temperature, that the temperature of the terminal device is too high, and then reconfigures the DRX parameter, for example, reduces an onDurationTimer parameter and an InactivityTimer parameter, so that the terminal device can enter a sleep mode as soon as possible to reduce power consumption and prolong battery service time.

In an embodiment of the present disclosure, the terminal device may directly send a DRX parameter required by the terminal device to the network side device through the first configuration sub-request. In other words, the first configuration sub-request includes the DRX parameter. It may be understood that the DRX parameter included in the first configuration sub-request may be: a DRX parameter in an idle state, and/or a DRX parameter in an inactive state, and/or a DRX parameter in a connected state.

The DRX parameter in the idle state may include at least one of a DRX cycle parameter in an idle state and a start moment parameter of a DRX cycle in an idle state.

The DRX parameter in the inactive state may include at least one of a DRX cycle parameter in an inactive state and a start moment parameter of a DRX cycle in an inactive state.

The DRX parameter in the connected state may include one or more of an onDurationTimer parameter, an InactivityTimer parameter, a long cycle related parameter, a short cycle related parameter, and a retransmission related parameter.

The terminal device in the idle state or the inactive state has a corresponding paging moment (that is, the DRX cycle start moment). The paging moment of the terminal device is identified by a paging frame (Paging Frame, PF) parameter and a paging occasion (Paging Occasion, PO) parameter. The PF indicates a system frame number on which the paging message should appear, and the PO indicates a moment at which a subframe may appear. A PF frame may include one or more PO subframes. In each DRX cycle, the terminal device only needs to monitor the PO subframe that belongs to the terminal device. A location of a PO subframe is jointly determined by an LTE system type, a parameter Ns, and a parameter i_s. Ns indicates a quantity of paging subframes in each PF, and i_s indicates an index of a paging subframe. The LTE system type includes: frequency division duplexing (Frequency Division Duplexing, FDD) and time division duplexing (Time Division Duplexing, TDD).

The onDurationTimer parameter indicates an online duration after the terminal device wakes up in a DRX cycle.

The InactivityTimer parameter indicates a quantity of PDCCH subframes that need to be continuously monitored after the terminal device is successfully decoded to a downlink PDCCH subframe.

The retransmission related parameter includes: a hybrid automatic repeat request (Hybrid Automatic Repeat Request, HARQ) round-trip time (Round-Trip Time, RTT) Timer parameter and a RetransmissionTimer parameter.

The HARQ RTT Timer parameter includes: a downlink HARQ RTT timer (HARQ RTT TimerDL) parameter and an uplink HARQ RTT timer (HARQ RTT TimerUL) parameter. The RetransmissionTimer parameter includes: a downlink retransmission timer (RetransmissionTimerDL) parameter and an uplink retransmission timer (RetransmissionTimerUL) parameter.

If the terminal device receives a HARQ initial transmission/retransmission control signaling, the HARQ RTT Timer is turned on. If data in a corresponding HARQ process is still decoded unsuccessfully after a previous HARQ transmission, after the HARQ RTT Timer times out, the terminal device starts the RetransmissionTimer. If data in a corresponding HARQ process is decoded successfully after a previous HARQ transmission, after the HARQ RTT Timer times out, the terminal device does not start the RetransmissionTimer. The RetransmissionTimerDL parameter indicates a maximum quantity of PDCCH subframes that need to be continuously monitored by the terminal device to receive expected downlink retransmission data. The RetransmissionTimerUL parameter indicates a maximum quantity of PDCCH subframes that need to be continuously monitored by the terminal device to send expected uplink retransmission data.

The long cycle related parameter includes: a longDRX-CycleStartOffset parameter, which simultaneously indicates a long cycle duration used by a DRX (longDRX-Cycle) and a start subframe of a long cycle (drxStartOffset).

The short cycle related parameter includes: a ShortDRX-Cycle parameter, a ShortCycleTimer parameter, and a SlotOffset parameter. The ShortDRX-Cycle parameter indicates a short cycle duration used by a DRX; the ShortCycleTimer parameter indicates a quantity of subframes in a short cycle that enter a long cycle when no PDCCH subframe is received; and the SlotOffset parameter indicates a start subframe of a short cycle.

For example, it is assumed that a DRX cycle that is in an idle state and that is configured by the network side device for the terminal device is 200 ms. However, the terminal device finds that under the current DRX parameter configuration, in the 200 ms DRX cycle in the idle state, a probability that the terminal device receives a paging signal belonging to the terminal device is low. In this case, the terminal device sends the first configuration sub-request for the DRX parameter to the network side device, where the first configuration sub-request includes the following: The DRX cycle in the idle state is configured as 20 ms. Then, the network side device reconfigures, based on the first configuration sub-request, the DRX cycle in the idle state as 20 ms.

For example, it is assumed that the network side device has enabled a DRX function for the terminal device, and has configured the RetransmissionTimerDL as 40 ms. However, the terminal device finds that under the current DRX parameter configuration, in the 40 ms RetransmissionTimerDL, there are a lot of scenarios in which a PDCCH is blindly detected but no PDCCH subframe is detected. In this case, the terminal device sends the first configuration sub-request for the DRX parameter to the network side device, where the first configuration sub-request includes the following: The RetransmissionTimerDL is configured as 24 ms. Then, the network side device reconfigures, based on the first configuration sub-request, the RetransmissionTimerDL as 24 ms.

For example, it is assumed that the network side device has enabled a DRX function for the terminal device, and has configured the InactivityTimer as 200 ms. However, the terminal device finds that under the current DRX parameter configuration, in the 200 ms InactivityTimer, there are a lot of scenarios in which a PDCCH is blindly detected but no PDCCH subframe is detected. In this case, the terminal device sends the first configuration sub-request for the DRX parameter to the network side device, where the first configuration sub-request includes the following: The InactivityTimer is configured as 20 ms. Then, the network side device reconfigures, based on the first configuration sub-request, the InactivityTimer as 20 ms.

In an embodiment of the present disclosure, when the first configuration sub-request for the DRX parameter, sent by the terminal device to the network side device, carries the DRX parameter, the network side device may feed back confirmation information only to the terminal device, where the confirmation information does not carry the DRX parameter. Certainly, the network side device may also send, to the terminal device, feedback information in response to the first configuration sub-request, where the feedback information includes a reconfigured DRX parameter.

In an embodiment of the present disclosure, when the first configuration sub-request for the DRX parameter, sent by the terminal device to the network side device, does not carry the DRX parameter, feedback information that is sent by the network side device to the terminal device and that is in response to the first configuration sub-request necessarily includes a reconfigured DRX parameter.

In an embodiment of the present disclosure, the network side device may reconfigure a DRX parameter through radio resource control (Radio Resource Control, RRC), media access control (Media Access Control, MAC), or downlink control information (Downlink Control Information, DCI).

The RRC is used to allocate radio resources and send related signaling. An RRC message is a main part of control signaling between the terminal device and an evolved universal terrestrial radio access network (Evolved Universal Terrestrial Radio Access Network, UTRAN), and carries all parameters that are required to establish, modify, and release MAC layer and physical layer protocol entities.

The DCI is carried by a PDCCH, and the DCI sent by the network side device to the terminal device includes: uplink and downlink resource allocation, HARQ information, power control, and the like.

In an embodiment of the present disclosure, the terminal device may also send the second configuration sub-request for the RRC state to the network side device, where the second configuration sub-request is used for the network side device to configure the RRC state.

For example, it is assumed that the terminal device is currently in a connected state. However, the terminal device finds that in the connected state, there are a lot of scenarios in which a PDCCH is blindly detected but no PDCCH subframe is detected, or the terminal device has no uplink service and/or downlink service for a period of time, in this case, the terminal device sends the second configuration sub-request for the RRC state to the network side device, where the second configuration sub-request includes a reconfigured RRC state (for example, an idle state or an inactive state). Then, the network side device may reconfigure, based on the second configuration sub-request, the RRC state as the idle state or the inactive state.

For example, it is assumed that the terminal device is currently in a connected state. However, the terminal device finds that in the connected state, no PDCCH is detected in a plurality of long DRX cycles. In this case, the terminal device sends the second configuration sub-request for the RRC state to the network side device, where the second configuration sub-request includes a reconfigured RRC state (for example, an idle state or an inactive state). Then, the network side device reconfigures, based on the second configuration sub-request, the RRC state as the idle state or the inactive state.

It may be understood that, to achieve the effects of improving data transmission efficiency and saving power of the terminal device in the present disclosure, the reconfiguring the RRC state in this embodiment of the present disclosure is as follows: switching from the connected state to the idle state or the inactive state, or switching from the inactive state to the idle state.

In an embodiment of the present disclosure, the terminal device may also send the third configuration sub-request for the component carrier and/or the BWP to the network side device, where the third configuration sub-request is used for the network side device to configure the component carrier and/or the BWP. The third configuration sub-request may include one or more of a quantity of downlink active component carriers activated simultaneously, a quantity of uplink active component carriers activated simultaneously, identification information of active BWPs, and a quantity of the active BWPs.

For example, it is assumed that a service of the terminal device in this case is a video service, and the network side device configures two carriers for the terminal device, but in fact, the video service only needs one carrier to transmit data. In this case, the terminal device sends the third configuration sub-request to the network side device, where the third configuration sub-request includes the quantity of the simultaneously active uplink component carriers, that is 1. The network side device reconfigures the component carrier based on the quantity that is of the simultaneously active uplink component carriers and that is included in the third configuration sub-request.

A process of reconfiguring, by the network side device, the component carrier based on the quantity of the simultaneously active downlink component carriers is the same as that of reconfiguring, by the network side device, the component carrier based on the quantity of the simultaneously active uplink component carriers, which is not described in detail in this embodiment of the present disclosure.

For example, it is assumed that the terminal device is currently configured with two active BWPs. However, the terminal device finds that in this case, only one active BWP is needed. In this case, the terminal device may send, to the network side device, the third configuration sub-request that includes identification information of the active BWPs and/or the quantity of the active BWPs. The network side device configures the BWP based on the identification information of the active BWPs and/or the quantity of the active BWPs included in the second configuration sub-request. The foregoing BWP may be an uplink BWP, a downlink BWP, or an uplink BWP and a downlink BWP.

In an embodiment of the present disclosure, when the first configuration sub-request for the DRX parameter, sent by the terminal device to the network side device, carries the DRX parameter, the second configuration sub-request for the RRC state carries the RRC state, and the third configuration sub-request for the component carrier and/or the BWP carries the component carrier and/or the BWP, the network side device may feed back confirmation information only to the terminal device, where the confirmation information does not carry the DRX parameter, the RRC state, the component carrier, and the BWP. Certainly, the network side device may also send, to the terminal device, feedback information in response to the configuration request, where the feedback information includes a reconfigured DRX parameter, a reconfigured RRC state, and a reconfigured component carrier and/or a reconfigured BWP.

In an embodiment of the present disclosure, when the first configuration sub-request for the DRX parameter, sent by the terminal device to the network side device, does not carry the DRX parameter, the second configuration sub-request for the RRC state does not carry the RRC state, and the third configuration sub-request for the component carrier and/or the BWP does not carry the component carrier and/or the BWP, feedback information that is sent by the network side device to the terminal device and that is in response to the configuration request necessarily includes a reconfigured DRX parameter, a reconfigured RRC state, and a reconfigured component carrier and/or a reconfigured BWP.

According to the data service processing method provided in this embodiment of the present disclosure, the network side device receives the configuration request sent by the terminal device, and sends, to the terminal device, the feedback information in response to the configuration request; and the terminal device performs the data service processing based on the feedback information. A probability that the terminal device blindly detects a PDCCH but no PDCCH is detected can be reduced, so as to improve data transmission efficiency and save power of the terminal device.

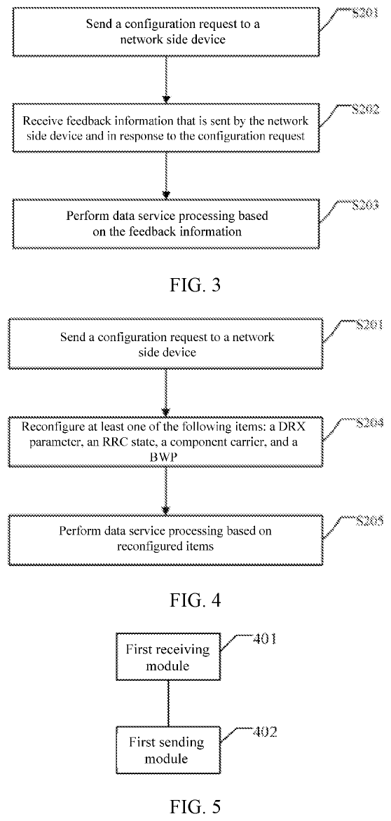

An embodiment of the present disclosure provides a data service processing method applied to a terminal device. As shown in FIG. 3, FIG. 3 is a first schematic flowchart of the data service processing method applied to the terminal device according to an embodiment of the present disclosure. The data service processing method applied to the terminal device may include the following steps:

S201: Send a configuration request to a network side device.

The configuration request includes one or more of a first configuration sub-request for a DRX parameter, a second configuration sub-request for an RRC state, and a third configuration sub-request for a component carrier and a BWP.

S202: Receive feedback information that is sent by the network side device in response to the configuration request.

S203: Perform data service processing based on the feedback information.

Compared with the network side device, the terminal device can learn some information better in real time, such as uplink service information, a remaining battery life of the terminal device, and whether a body of the terminal device is overheated. Therefore, the terminal device can determine a more appropriate DRX parameter, RRC state, and component carrier and/or bandwidth part BWP, and report the DRX parameter, RRC state, and component carrier and/or bandwidth part BWP to the network side device, so that a probability that the terminal device blindly detects a PDCCH but no PDCCH is detected is reduced, and the effects of improving data transmission efficiency and saving power of the terminal device are achieved.

Based on this, the terminal device can send, to the network side device, the configuration request that includes the first configuration sub-request for the DRX parameter, the second configuration sub-request for the RRC state, and/or the third configuration sub-request for the component carrier and/or the BWP. The network side device responds to the configuration request, and then the terminal device performs the data service processing based on the response of the network side device.

In an embodiment of the present disclosure, the first configuration sub-request for the DRX parameter, sent by the terminal device to the network side device, may be an initial configuration request for a DRX parameter or a reconfiguration request for a DRX parameter.

In an embodiment of the present disclosure, the terminal device may send the configuration request through a PUSCH, a PUCCH, or a PRACH.

In an embodiment of the present disclosure, the terminal device may send a factor that affects a DRX parameter to the network side device through the first configuration sub-request. In other words, the first configuration sub-request includes: the factor that affects the DRX parameter. The network side device reconfigures the DRX parameter based on the factor that affects the DRX parameter and that is in the received first configuration sub-request. The factor that affects the DRX parameter may include one or more of an uplink service packet arrival cycle, an uplink service packet size, an uplink data transmission rate, an uplink service delay requirement, a downlink service packet arrival cycle, a downlink service packet size, a downlink data transmission rate, a downlink service delay requirement, a remaining battery life of the terminal device, and a temperature of the terminal device.

In an embodiment of the present disclosure, the terminal device may directly send a DRX parameter required by the terminal device to the network side device through the first configuration sub-request. In other words, the first configuration sub-request includes the DRX parameter. It may be understood that the DRX parameter included in the first configuration sub-request may be: a DRX parameter in an idle state, and/or a DRX parameter in an inactive state, and/or a DRX parameter in a connected state.

The DRX parameter in the idle state may include at least one of a DRX cycle parameter in an idle state and a start moment parameter of a DRX cycle in an idle state.

The DRX parameter in the inactive state may include at least one of a DRX cycle parameter in an inactive state and a start moment parameter of a DRX cycle in an inactive state.

The DRX parameter in the connected state may include one or more of an onDurationTimer parameter, an InactivityTimer parameter, a long cycle related parameter, a short cycle related parameter, and a retransmission related parameter.

In an embodiment of the present disclosure, the third configuration sub-request may include one or more of a quantity of downlink active component carriers activated simultaneously, a quantity of uplink active component carriers activated simultaneously, identification information of active BWPs, and a quantity of the active BWPs.

In an embodiment of the present disclosure, when the first configuration sub-request for the DRX parameter, sent by the terminal device to the network side device, carries the DRX parameter, the second configuration sub-request for the RRC state carries the RRC state, and the third configuration sub-request for the component carrier and/or the BWP carries the component carrier and/or the BWP, the network side device may feed back confirmation information only to the terminal device, where the confirmation information does not carry the DRX parameter, the RRC state, the component carrier, and the BWP. Certainly, the network side device may also send, to the terminal device, feedback information in response to the configuration request, where the feedback information includes a reconfigured DRX parameter, a reconfigured RRC state, and a reconfigured component carrier and/or a reconfigured BWP.

In an embodiment of the present disclosure, when the first configuration sub-request for the DRX parameter, sent by the terminal device to the network side device, does not carry the DRX parameter, the second configuration sub-request for the RRC state does not carry the RRC state, and the third configuration sub-request for the component carrier and/or the BWP does not carry the component carrier and/or the BWP, feedback information that is sent by the network side device to the terminal device and that is in response to the configuration request necessarily includes a reconfigured DRX parameter, a reconfigured RRC state, and a reconfigured component carrier and/or a reconfigured BWP.

According to the data service processing method provided in this embodiment of the present disclosure, the terminal device sends the configuration request to the network side device; the network side device sends, to the terminal device, the feedback information in response to the configuration request; and the terminal device performs the data service processing based on the feedback information. A probability that the terminal device blindly detects a PDCCH but no PDCCH is detected can be reduced, so as to improve data transmission efficiency and save power of the terminal device.

It may be understood that in the data service processing method applied to the terminal device in the embodiment shown in FIG. 3 of the present disclosure, the network side device needs to send, to the terminal device, the feedback information in response to the configuration request, and the terminal device performs the data service processing based on the feedback information after receiving the feedback information. In an embodiment of the present disclosure, the terminal device may configure the DRX parameter, the RRC state, and the component carrier and/or the BWP by itself, and then perform the data service processing based on a reconfigured DRX parameter, a reconfigured RRC state, and a reconfigured component carrier and/or a reconfigured BWP. Based on this, an embodiment of the present disclosure further provides a data service processing method applied to a terminal device. As shown in FIG. 4, FIG. 4 is a second schematic flowchart of the data service processing method applied to the terminal device according to an embodiment of the present disclosure. The data service processing method applied to the terminal device may include the following steps:

S201: Send a configuration request to a network side device.

S204: Reconfigure one or more of a DRX parameter, an RRC state, a component carrier, and a BWP.

S205: Perform data service processing based on reconfigured items.

According to the data service processing method provided in this embodiment of the present disclosure, the terminal device may configure the DRX parameter, the RRC state, and the component carrier and/or the BWP by itself, so as to improve data transmission efficiency and save power of the terminal device.

Corresponding to the embodiment of the data service processing method applied to the network side device shown in FIG. 2, an embodiment of the present disclosure further provides a network side device. As shown in FIG. 5, FIG. 5 is a schematic structural diagram of the network side device according to an embodiment of the present disclosure. The network side device may include: a first receiving module 401 and a first sending module 402.

The first receiving module 401 is configured to receive a configuration request from a terminal device.

The configuration request includes one or more of a first configuration sub-request for a DRX parameter, a second configuration sub-request for a radio resource control RRC state, and a third configuration sub-request for a component carrier and a BWP.

The first sending module 402 is configured to send, to the terminal device, feedback information in response to the configuration request, so that the terminal device performs data service processing based on the feedback information.

In an embodiment of the present disclosure, the first receiving module 401 may be specifically configured to: receive the configuration request from the terminal device through a PUSCH, a PUCCH, or a PRACH.

In an embodiment of the present disclosure, the first configuration sub-request may include one or more of a factor that affects a DRX parameter, a DRX parameter in an idle state, a DRX parameter in an inactive state, and a DRX parameter in a connected state.

The factor that affects the DRX parameter may include one or more of an uplink service packet arrival cycle, an uplink service packet size, an uplink data transmission rate, an uplink service delay requirement, a downlink service packet arrival cycle, a downlink service packet size, a downlink data transmission rate, a downlink service delay requirement, a remaining battery life of the terminal device, and a temperature of the terminal device.

The DRX parameter in the idle state may include at least one of a DRX cycle parameter in an idle state and a start moment parameter of a DRX cycle in an idle state.

The DRX parameter in the inactive state may include at least one of a DRX cycle parameter in an inactive state and a start moment parameter of a DRX cycle in an inactive state.

The DRX parameter in the connected state may include one or more of an onDurationTimer parameter, an InactivityTimer parameter, a long cycle related parameter, a short cycle related parameter, and a retransmission related parameter.

In an embodiment of the present disclosure, the third configuration sub-request may include one or more of a quantity of downlink active component carriers activated simultaneously, a quantity of uplink active component carriers activated simultaneously, identification information of active BWPs, and a quantity of the active BWPs.

In an embodiment of the present disclosure, the feedback information may include one or more of the reconfigured DRX parameter, the reconfigured RRC state, the reconfigured component carrier, and the reconfigured BWP.

In an embodiment of the present disclosure, the reconfigured DRX parameter may be reconfigured through RRC, MAC, or DCI.

According to the network side device provided in this embodiment of the present disclosure, the configuration request sent by the terminal device is received, and feedback information in response to the configuration request is sent to the terminal device; and the terminal device performs the data service processing based on the feedback information. A probability that the terminal device blindly detects a PDCCH but no PDCCH is detected can be reduced, so as to improve data transmission efficiency and save power of the terminal device.

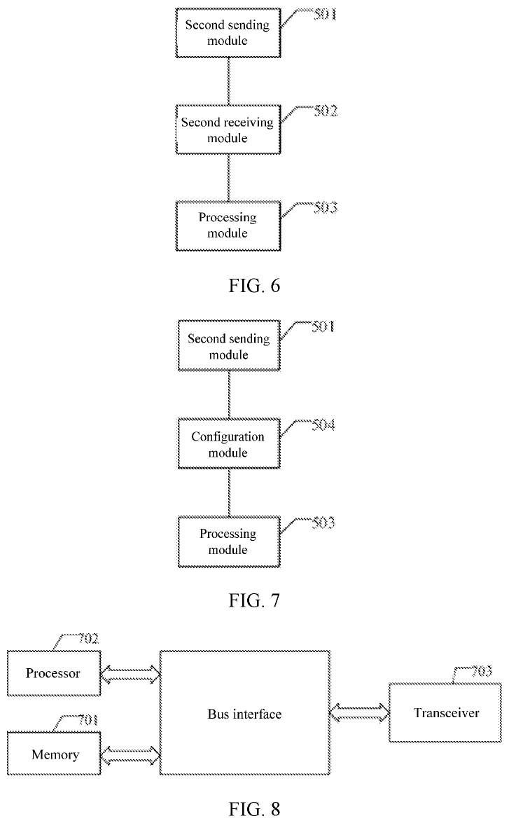

Corresponding to the embodiment of the data service processing method applied to the terminal device shown in FIG. 3, an embodiment of the present disclosure further provides a terminal device. As shown in FIG. 6, FIG. 6 is a schematic structural diagram of the terminal device according to an embodiment of the present disclosure. The terminal device may include: a second sending module 501, a second receiving module 502, and a processing module 503.

The second sending module 501 is configured to send a configuration request to a network side device.

The configuration request includes one or more of a first configuration sub-request for a DRX parameter, a second configuration sub-request for an RRC state, and a third configuration sub-request for a component carrier and/or a BWP.

The second receiving module 502 is configured to receive feedback information that is sent by the network side device in response to the configuration request.

The processing module 503 is configured to perform data service processing based on the feedback information received by the second receiving module 502.

In an embodiment of the present disclosure, the second sending module 501 may be specifically configured to: send the configuration request to the network side device through a PUSCH, a PUCCH, or a PRACH.

In an embodiment of the present disclosure, the first configuration sub-request may include one or more of a factor that affects a DRX parameter, a DRX parameter in an idle state, a DRX parameter in an inactive state, and a DRX parameter in a connected state.

The factor that affects the DRX parameter includes one or more of an uplink service packet arrival cycle, an uplink service packet size, an uplink data transmission rate, an uplink service delay requirement, a downlink service packet arrival cycle, a downlink service packet size, a downlink data transmission rate, a downlink service delay requirement, a remaining battery life of the terminal device, and a temperature of the terminal device.

The DRX parameter in the idle state may include at least one of a DRX cycle parameter in an idle state and a start moment parameter of a DRX cycle in an idle state.

The DRX parameter in the inactive state includes at least one of a DRX cycle parameter in an inactive state and a start moment parameter of a DRX cycle in an inactive state.

The DRX parameter in the connected state includes one or more of an onDurationTimer parameter, an InactivityTimer parameter, a long cycle related parameter, a short cycle related parameter, and a retransmission related parameter.

In an embodiment of the present disclosure, the third configuration sub-request may include one or more of a quantity of downlink active component carriers activated simultaneously, a quantity of uplink active component carriers activated simultaneously, identification information of active BWPs, and a quantity of the active BWPs.

In an embodiment of the present disclosure, the feedback information may include one or more of the reconfigured DRX parameter, the reconfigured RRC state, the reconfigured component carrier, and the reconfigured BWP.

According to the terminal device provided in this embodiment of the present disclosure, the configuration request is sent to the network side device, the feedback information that is sent by the network side device in response to the configuration request is received, and the data service processing is performed based on the feedback information. A probability that the terminal device blindly detects a PDCCH but no PDCCH is detected can be reduced, so as to improve data transmission efficiency and save power of the terminal device.

Corresponding to the embodiment of the data service processing method applied to the terminal device shown in FIG. 4, an embodiment of the present disclosure further provides a terminal device. As shown in FIG. 7, FIG. 7 is a second schematic structural diagram of the terminal device according to an embodiment of the present disclosure. The terminal device may include: a second sending module 501, a configuration module 504, and a processing module 503.

The configuration module 504 is configured to reconfigure one or more of a DRX parameter, an RRC state, a component carrier, and a BWP.

The processing module 503 is configured to perform data service processing based on items reconfigured by the configuration module 504.

According to the terminal device provided in this embodiment of the present disclosure, the terminal device may configure the DRX parameter, the RRC state, and the component carrier and/or the BWP by itself, so as to improve data transmission efficiency and save power of the terminal device.

In an embodiment of the present disclosure, the terminal device provided in this embodiment of the present disclosure may alternatively include the foregoing four modules of the second sending module 501, the second receiving module 502, the processing module 503, and the configuration module 504 at the same time.

FIG. 8 is a schematic structural diagram of hardware of a network side device according to an embodiment of the present disclosure. The network side device includes a memory 701, a processor 702, a transceiver 703, and a computer program stored in the memory 701 and executable on the processor 702.

The processor 702 may be configured to: receive a configuration request from a terminal device, and send, to the terminal device, feedback information in response to the configuration request, so that the terminal device performs data service processing based on the feedback information. The configuration request includes one or more of a first configuration sub-request for a DRX parameter, a second configuration sub-request for a radio resource control RRC state, and a third configuration sub-request for a component carrier and a BWP.

In an embodiment of the present disclosure, the processor 702 may be specifically configured to: receive the configuration request from the terminal device through a PUSCH, a PUCCH, or a PRACH.

In an embodiment of the present disclosure, the first configuration sub-request may include one or more of a factor that affects a DRX parameter, a DRX parameter in an idle state, a DRX parameter in an inactive state, and a DRX parameter in a connected state.

The factor that affects the DRX parameter may include one or more of an uplink service packet arrival cycle, an uplink service packet size, an uplink data transmission rate, an uplink service delay requirement, a downlink service packet arrival cycle, a downlink service packet size, a downlink data transmission rate, a downlink service delay requirement, a remaining battery life of the terminal device, and a temperature of the terminal device.

The DRX parameter in the idle state may include a DRX cycle parameter in an idle state and/or a start moment parameter of a DRX cycle in an idle state.

The DRX parameter in the inactive state may include a DRX cycle parameter in an inactive state and/or a start moment parameter of a DRX cycle in an inactive state.

The DRX parameter in the connected state may include one or more of an onDurationTimer parameter, an InactivityTimer parameter, a long cycle related parameter, a short cycle related parameter, and a retransmission related parameter.

In an embodiment of the present disclosure, the third configuration sub-request may include one or more of a quantity of downlink active component carriers activated simultaneously, a quantity of uplink active component carriers activated simultaneously, identification information of active BWPs, and a quantity of the active BWPs.

In an embodiment of the present disclosure, the feedback information may include one or more of the reconfigured DRX parameter, the reconfigured RRC state, the reconfigured component carrier, and the reconfigured BWP.

In an embodiment of the present disclosure, the processor 702 may be further configured to: reconfigure the DRX parameter through RRC, MAC, or DCI.

In FIG. 7, a bus architecture may include any quantity of interconnected buses and bridges, which are specifically connected together by one or more processors represented by the processor 702 and various circuits of a memory represented by the memory 701. The bus architecture may further connect together various other circuits of a peripheral device, a voltage stabilizer, a power management circuit, and the like, which are known in this art and will not be further described herein. The bus interface provides an interface. The transceiver 703 may include a plurality of elements, that is, include a transmitter and a receiver, may provide units for communication with various other apparatuses on a transmission medium, and may be configured to receive and send data under control of the processor 702. The processor 702 is responsible for management of the bus architecture and general processing. The memory 701 may store data used by the processor 702 when operations are performed.

Optionally, an embodiment of the present disclosure further provides a network side device, including: a processor 702, a memory 701, and a computer program stored in the memory 701 and executable on the processor 702, where the computer program, when executed by the processor 702, implements the processes of the embodiment of the data service processing method applied to the network side device, and the same technical effects can be achieved. To avoid repetition, details are not described herein again.

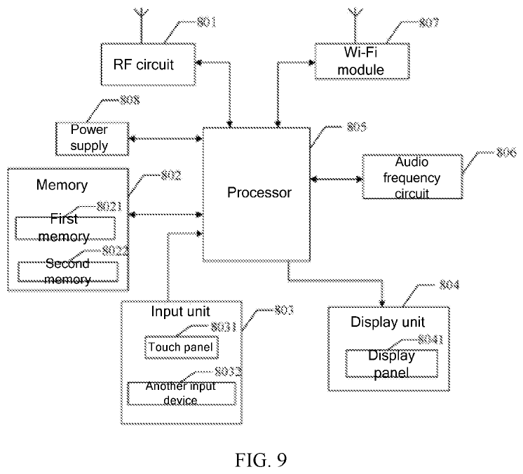

FIG. 9 is a schematic structural diagram of hardware of a terminal device according to an embodiment of the present disclosure. The terminal device includes but is not limited to: a radio frequency (Radio Frequency, RF) circuit 801, a memory 802, an input unit 803, a display unit 804, a processor 805, an audio frequency circuit 806, a wireless-fidelity (Wireless-Fidelity, Wi-Fi) module 807, and a power supply 808. A person skilled in the art may understand that the structure of the terminal device shown in FIG. 8 does not constitute a limitation to the terminal device. The terminal device may include more or fewer components than that shown in the figure, or a combination of some components, or an arrangement of different components. In this embodiment of the present disclosure, the terminal device includes but is not limited to a mobile phone, a tablet computer, a notebook computer, a palmtop computer, a vehicle-mounted terminal, a wearable device, a pedometer, or the like.

The RF circuit 801 may be configured to receive and transmit information, or receive and transmit signals during a call. Specifically, the RF circuit 801 receives downlink data from a network side device, and transmits the downlink data to the processor 805 for processing; and in addition, transmits uplink data to the network side device. Generally, the RF circuit 801 includes but is not limited to an antenna, at least one amplifier, a transceiver, a coupler, a low noise amplifier, a duplexer, and the like. In addition, the RF circuit 801 may also communicate with another device through a wireless communications system and network.

The memory 802 may be configured to store software programs and various data. The memory 802 may mainly include a program storage area and a data storage area. The program storage area may store an operating system, an application program required by at least one function (such as a sound playback function and an image playback function), and the like. The data storage area may store data (such as audio data and a phone book) created based on use of the terminal device, and the like. In addition, the memory 802 may include a high-speed random access memory or a nonvolatile memory, for example, at least one disk storage device, a flash memory, or another volatile solid-state storage device. The memory 802 may include a first memory 8021 that stores software programs and/or modules and a second memory 8022 that stores data.

The input unit 803 may be configured to receive numeric or character information input by a user, and generate signal inputs related to user settings and function control of the terminal device. Specifically, in this embodiment of the present disclosure, the input unit 803 may include a touch panel 8031. The touch panel 8031, also called a touch screen, can collect a touch operation of the user on or near the touch panel 8031 (For example, the user uses any suitable object or accessory such as a finger or a stylus to operate on the touch panel 8031), and drive a corresponding connecting apparatus based on a preset program. Optionally, the touch panel 8031 may include two parts: a touch detection apparatus and a touch controller. The touch detection apparatus detects a touch position of the user, detects a signal brought by the touch operation, and transmits the signal to the touch controller. The touch controller receives touch information from the touch detection apparatus, converts the touch information into contact coordinates, transmits the contact coordinates to the processor 805, receives a command sent by the processor 805, and executes the command. In addition, the touch panel 8031 can be implemented in various types such as resistive, capacitive, infrared, and surface acoustic wave. In addition to the touch panel 8031, the input unit 803 may further include another input device 8032, where the another input device 8032 may include but is not limited to one or more of a physical keyboard, function keys (such as a volume control key and a switch key), a trackball, a mouse, a joystick, and the like.

The display unit 804 may be configured to display information input by the user or information provided to the user, and various menu interfaces of the terminal device. The display unit 804 may include a display panel 8041, and optionally the display panel 8041 may be configured in a form of a liquid crystal display (Liquid Crystal Display, LCD), an organic light-emitting diode (Organic Light-Emitting Diode, OLED), or the like.

It should be noted that the touch panel 8031 may cover the display panel 8041 to form a touch display. When detecting a touch operation on or near the touch display, the touch display transmits the touch operation to the processor 805 to determine a type of a touch event. Then the processor 805 provides corresponding visual output on the touch display based on the type of the touch event.

The touch display includes an application program interface display area and a common control display area. An arrangement manner of the application program interface display area and the common control display area is not limited, and may be in an arrangement manner that can distinguish two display areas, such as up and down, or left and right. The application program interface display area may be configured to display an interface of an application program. Each interface may include interface elements, such as an icon and/or a widget desktop control of at least one application program. The application program interface display area may alternatively be an empty interface that includes no content. The common control display area is configured to display controls having higher usage rates, for example, application icons such as a setting button, an interface number, a scroll bar, and a phone book icon.

The processor 805 is a control center of the terminal device, connects various parts of the entire terminal device by using various interfaces and circuits, and performs various functions of the terminal device and processes data by running or executing the software programs and/or the modules stored in the first memory 8021 and invoking data stored in the second memory 8022, so as to monitor the terminal device as a whole. Optionally, the processor 805 may include one or more processing units.

In this embodiment of the present disclosure, by invoking the software programs and/or the modules stored in the first memory 8021 and/or the data stored in the second memory 8022, the processor 805 may be configured to: send a configuration request to the network side device; and reconfigure one or more of a DRX parameter, an RRC state, a component carrier, and a BWP, and perform data service processing based on reconfigured items; or receive feedback information that is sent by the network side device in response to the configuration request, and perform data service processing based on the feedback information. The configuration request includes one or more of a first configuration sub-request for a DRX parameter, a second configuration sub-request for a radio resource control RRC state, and a third configuration sub-request for a component carrier and a BWP.

In an embodiment of the present disclosure, the processor 805 may be specifically configured to: send the configuration request to the network side device through a PUSCH, a PUCCH, or a PRACH.

In an embodiment of the present disclosure, the first configuration sub-request may include one or more of a factor that affects a DRX parameter, a DRX parameter in an idle state, a DRX parameter in an inactive state, and a DRX parameter in a connected state.

The factor that affects the DRX parameter may include one or more of an uplink service packet arrival cycle, an uplink service packet size, an uplink data transmission rate, an uplink service delay requirement, a downlink service packet arrival cycle, a downlink service packet size, a downlink data transmission rate, a downlink service delay requirement, a remaining battery life of the terminal device, and a temperature of the terminal device.

The DRX parameter in the idle state may include a DRX cycle parameter in an idle state and/or a start moment parameter of a DRX cycle in an idle state.

The DRX parameter in the inactive state may include a DRX cycle parameter in an inactive state and/or a start moment parameter of a DRX cycle in an inactive state.

The DRX parameter in the connected state may include one or more of an onDurationTimer parameter, an InactivityTimer parameter, a long cycle related parameter, a short cycle related parameter, and a retransmission related parameter.

In an embodiment of the present disclosure, the third configuration sub-request may include one or more of a quantity of downlink active component carriers activated simultaneously, a quantity of uplink active component carriers activated simultaneously, identification information of active BWPs, and a quantity of the active BWPs.

In an embodiment of the present disclosure, the feedback information may include one or more of the reconfigured DRX parameter, the reconfigured RRC state, the reconfigured component carrier, and the reconfigured BWP.

The audio frequency circuit 806 may convert audio data received by the RF circuit 801 or the Wi-Fi module 807 or stored in the memory 802 into an audio signal, and output the audio signal into sound. In addition, the audio frequency circuit 806 may also provide audio output related to a specific function performed by the terminal device (for example, call signal receiving sound or message receiving sound). The audio frequency circuit 806 includes a speaker, a buzzer, a receiver, and the like.

The Wi-Fi module 807 provides the user with wireless broadband Internet access, for example, helps the user send and receive emails, browse web pages, and access streaming media.

The power supply 808 may be logically connected to the processor 805 through a power supply management system, to perform functions of managing charging, discharging, and power consumption through the power supply management system.

In this way, the terminal device sends the configuration request to the network side device, receives the feedback information that is sent by the network side device in response to the configuration request, and performs the data service processing based on the feedback information. A probability that the terminal device blindly detects a PDCCH but no PDCCH is detected can be reduced, so as to improve data transmission efficiency and save power of the terminal device.

Optionally, an embodiment of the present disclosure further provides a terminal device, including: a processor 805, a memory 802, and a computer program stored in the memory 802 and executable on the processor 805, where the computer program, when executed by the processor 805, implements the processes of the embodiments of the data service processing method applied to the terminal device, and the same technical effects can be achieved. To avoid repetition, details are not described herein again.

An embodiment of the present disclosure further provides a computer readable storage medium, where the computer readable storage medium stores a computer program, the computer program, when executed by the processor, implements the processes of the foregoing embodiments of the data service processing method, and the same technical effects can be achieved. To avoid repetition, details are not described herein again. The computer readable storage medium may be a read-only memory (Read-Only Memory, ROM), a random access memory (Random Access Memory, RAM), a magnetic disk, a compact disc, or the like.

It should be clear that the present disclosure is not limited to the specific configuration and processing described above and shown in the figures. For brevity, a detailed description of a known method is omitted herein. In the foregoing embodiments, a plurality of specific steps are described and shown as examples. However, the method process in the present disclosure is not limited to the specific steps described and shown, and a person skilled in the art can make various changes, modifications and additions, or change the sequence between the steps after understanding the spirit of the present disclosure.

It should also be noted that in the exemplary embodiments mentioned in the present disclosure, some methods or systems are described based on a series of steps or apparatuses. However, the present disclosure is not limited to the sequence of the foregoing steps. In other words, the steps may be performed in the sequence mentioned in the embodiments, or performed in the sequence different from that in the embodiments, or a plurality of steps may be performed simultaneously.

The foregoing descriptions are merely specific implementations of the present disclosure. A person skilled in the art can clearly understand that to describe conveniently and concisely, for a specific working process of the system, module, and unit described above, refer to the corresponding process in the foregoing method embodiments. Details are not described herein again. It should be understood that the protection scope of the present disclosure is not limited to this. Any equivalent modification or replacement readily figured out by a person skilled in the art within the technical scope disclosed in the present disclosure shall fall within the protection scope of the present disclosure.

1. A method for data service processing, comprising:
sending a configuration request to a network side device, wherein the configuration request comprises one or more of a first configuration sub-request for a Discontinuous Reception (DRX) parameter, a second configuration sub-request for a Radio Resource Control (RRC) state, and a third configuration sub-request for a component carrier and a Bandwidth Part (BWP); and
reconfiguring one or more of the DRX parameter, the RRC state, the component carrier, and the BWP, and performing data service processing based on the reconfigured one or more of the DRX parameter, the RRC state, the component carrier, and the BWP; or
receiving feedback information that is sent by the network side device in response to the configuration request, and performing data service processing based on the feedback information.

2. The method according to claim 1, wherein sending a configuration request to a network side device comprises:
sending the configuration request to the network side device through a Physical Uplink Shared Channel (PUSCH), a Physical Uplink Control Channel (PUCCH), or a Physical Random Access Channel (PRACH).

3. The method according to claim 1, wherein the first configuration sub-request comprises one or more of a factor that affects a DRX parameter, a DRX parameter in an idle state, a DRX parameter in an inactive state, and a DRX parameter in a connected state.

4. The method according to claim 3, wherein the factor that affects the DRX parameter comprises one or more of an uplink service packet arrival cycle, an uplink service packet size, an uplink data transmission rate, an uplink service delay requirement, a downlink service packet arrival cycle, a downlink service packet size, a downlink data transmission rate, a downlink service delay requirement, a remaining battery life of the terminal device, and a temperature of the terminal device.

5. The method according to claim 3, wherein the DRX parameter in the idle state comprises one or more of a DRX cycle parameter in an idle state and a start moment parameter of a DRX cycle in an idle state.

6. The method according to claim 3, wherein the DRX parameter in the inactive state comprises one or more of a DRX cycle parameter in an inactive state and a start moment parameter of a DRX cycle in an inactive state.

7. The method according to claim 3, wherein the DRX parameter in the connected state comprises one or more of an onDurationTimer parameter, an InactivityTimer parameter, a long cycle related parameter, a short cycle related parameter, and a retransmission related parameter.

8. The method according to claim 1, wherein the third configuration sub-request comprises one or more of a quantity of downlink active component carriers activated simultaneously, a quantity of uplink active component carriers activated simultaneously, identification information of active BWPs, and a quantity of the active BWPs.

9. The method according to claim 1, wherein the feedback information comprises one or more of the reconfigured DRX parameter, the reconfigured RRC state, the reconfigured component carrier, and the reconfigured BWP.

10. A terminal device, comprising:
a memory;
a processor; and
a computer program stored in the memory and executable on the processor, wherein the computer program, when executed by the processor, implements a method for data service processing, and the method comprising:
sending a configuration request to a network side device, wherein the configuration request comprises one or more of a first configuration sub-request for a discontinuous reception DRX parameter, a second configuration sub-request for a radio resource control RRC state, and a third configuration sub-request for a component carrier and a bandwidth part BWP; and
reconfiguring one or more of the DRX parameter, the RRC state, the component carrier, and the BWP, and performing data service processing based on the reconfigured one or more of the DRX parameter, the RRC state, the component carrier, and the BWP; or
receiving feedback information that is sent by the network side device in response to the configuration request, and performing data service processing based on the feedback information.

11. The terminal device according to claim 10, wherein sending a configuration request to a network side device comprises:
sending the configuration request to the network side device through a physical uplink shared channel PUSCH, a physical uplink control channel PUCCH, or a physical random access channel PRACH.

12. The terminal device according to claim 10, wherein the first configuration sub-request comprises one or more of a factor that affects a DRX parameter, a DRX parameter in an idle state, a DRX parameter in an inactive state, and a DRX parameter in a connected state.

13. The terminal device according to claim 12, wherein the factor that affects the DRX parameter comprises one or more of an uplink service packet arrival cycle, an uplink service packet size, an uplink data transmission rate, an uplink service delay requirement, a downlink service packet arrival cycle, a downlink service packet size, a downlink data transmission rate, a downlink service delay requirement, a remaining battery life of the terminal device, and a temperature of the terminal device.

14. The terminal device according to claim 12, wherein the DRX parameter in the idle state comprises one or more of a DRX cycle parameter in an idle state and a start moment parameter of a DRX cycle in an idle state.

15. The terminal device according to claim 12, wherein the DRX parameter in the inactive state comprises one or more of a DRX cycle parameter in an inactive state and a start moment parameter of a DRX cycle in an inactive state.

16. The terminal device according to claim 12, wherein the DRX parameter in the connected state comprises one or more of an onDurationTimer parameter, an InactivityTimer parameter, a long cycle related parameter, a short cycle related parameter, and a retransmission related parameter.

17. The terminal device according to claim 10, wherein the third configuration sub-request comprises one or more of a quantity of downlink active component carriers activated simultaneously, a quantity of uplink active component carriers activated simultaneously, identification information of active BWPs, and a quantity of the active BWPs.

18. The terminal device according to claim 10, wherein the feedback information comprises one or more of the reconfigured DRX parameter, the reconfigured RRC state, the reconfigured component carrier, and the reconfigured BWP.

19. A computer readable storage medium, storing a computer program that, when executed by the processor, causes the processor to implement a method for data service processing, the method comprising:
sending a configuration request to a network side device, wherein the configuration request comprises one or more of a first configuration sub-request for a discontinuous reception DRX parameter, a second configuration sub-request for a radio resource control RRC state, and a third configuration sub-request for a component carrier and a bandwidth part BWP; and
reconfiguring one or more of the DRX parameter, the RRC state, the component carrier, and the BWP, and performing data service processing based on the reconfigured one or more of the DRX parameter, the RRC state, the component carrier, and the BWP; or
receiving feedback information that is sent by the network side device in response to the configuration request, and performing data service processing based on the feedback information.

20. The computer readable storage medium according to claim 19, wherein sending a configuration request to a network side device comprises:
sending the configuration request to the network side device through a physical uplink shared channel PUSCH, a physical uplink control channel PUCCH, or a physical random access channel PRACH.
